(19) United States
(12) Patent Application Publication
(10) Pub. No.: US 2017/0276856 A1
(43) Pub. Date: Sep. 28, 2017

(54) Headlamp with Lateral/Rear Signaling

(71) Applicant: Zedel, Crolles (FR)

(72) Inventor: Thiphaine Gagneux, Grenoble (FR)

(21) Appl. No.: 15/465,690

(22) Filed: Mar. 22, 2017

(30) Foreign Application Priority Data
Mar. 22, 2016 (FR) 16/00477

(51) Int. Cl. F21V 8/00; A41D 1/00; G02B 5/02; A41D 20/00; F21V 33/00; F21L 4/00

(52) U.S. Cl. CPC G02B 6/0008; F21V 33/0008; G02B 6/001; F21L 4/00; G02B 5/0273; A41D 20/00; A41D 1/002

(57) ABSTRACT

A headlamp with frontal lamps and rear signaling is presented. The headlamp uses part of the light produced in the front lamp to achieve rear and/or lateral lighting and signaling. The headlamp has a housing which includes a light module, a light source and a holding strip for allowing the housing to be fixed to the head of a user. Tthe light module contains a module for connecting one or more optical fiber(s). The holding strip contains one or more optical fiber(s) having first and second ends. The first end is coupled to the connection module. The second end is coupled to at least one optical diffuser. A method of providing a headlamp with frontal lamps and rear signaling is also presented.

### TECHNICAL FIELD

The present invention relates to frontal lamps and in particular to a headlamp having a rear signaling.

### BACKGROUND ART

The headlamps have shown a significant development in the last few years and their use is spreading in all human activities, including professional, sports and recreational activities

Generally speaking, the source of energy which powers the lamp—be it a battery or accumulator—is housed in a housing placed in the headlamp itself, at the back of the head or even located, for example at the waist.

FIG. 1a illustrates an example of a conventional headlamp 2 comprising two front and rear housings respectively. A first housing 2 forms the body of the lamp, fitted with a light source 1 and control buttons 4 and 5, and is fixed at the front on the user's head. A second housing 6 serves for accommodating the power source and is positioned at the rear of the elastic band. Certain headlamps of this type use the presence of the rear housing to provide a rear signaling which is very useful for the safety of the lamp holder.

FIG. 1b shows another embodiment of a known headlamp 10 fixed on the user's head by means of an elastic band 11 and which further has a second casing 12 which is located, for example, to the waistband of the user.

In the so-called compact headlamps, the energy source is housed in the front, inside the housing forming the headlamp, so that the latter only requires an elastic band for its use. Due to their simplicity, but also their very low cost, these compact headlamps are very successful and their use tends to become widespread.

Unfortunately, the known compact lamps only allow a basic functionality, exclusive in particular of any possibility of rear signaling.

### SUMMARY

It is desirable to extend the possibilities of conventional compact lamps without excessive cost, in order to give them new functionalities, in particular as regards signaling and safety.

More generally, there is a need for extending the possibilities and functionalities of known headlamps, in particular the compact headlamps but also all others.

Such is the problem which is to be solved by the present invention.

It is an object of the present invention to achieve a new structure of headlamp, in particular a compact headlamp, which provides new functionalities of lateral and/or rear signaling.

It is another object of the present invention to provide a headlamp which is more userfriendly and having a higher level of use.

It is still another object of the present invention to carry out a compact headlamp that increases the user safety while reducing the manufacturing costs.

It is a further object of the present invention to achieve a headlamp which allows the use of part of the light produced within the front housing of the compact headlamp and its reuse for achieve rear and/or lateral lighting and signaling.

Those objects are achieved by means of a headlamp comprising a housing including a light module comprising a light source and a holding strip allowing the housing to be fixed to the head of a user,

The headlamp is characterized in that the light module comprises a module for connecting one or more optical fiber(s). Moreover, the holding strip comprises one or more optical fiber(s) having first and second end, the first end being coupled to the connection module and the second end being coupled to at least one optical diffuser.

In one particular embodiment, the optical fiber or fibers is/are arranged within the holding strip.

Alternatively, the optical fiber or fibers is/are arranged outside the holding strip.

Preferably, the optical diffuser is located at the rear of the holding strip.

In a specific embodiment, the holding strip comprises two lateral optical diffusers.

In one particular embodiment, the optical fiber or fibers is/are incorporated within the holding strip by means of a weaving process so as to form a pattern or a luminous logo.

Preferably, the holding strip comprises first, second and third parts, wherein the first portion is a left-handed rigid or semi-rigid portion having a first front end attached to the lamp casing and a second rear end. The second part is a rigid or semi-rigid, right-hand side part having a first front end fixed to the lamp casing and a second rear end. Finally, the third part is a resilient part allowing the connection of the rear ends of the first and second parts.

The invention is particularly adapted to the production of a compact lamp comprising the light module and a power source.

In another embodiment, a method of providing a headlamp with frontal lamps and rear signaling is presented.

### BRIEF DESCRIPTION OF THE DRAWINGS

Other features of one or more embodiments of the invention will appear from the following description of embodiments of the invention, with reference being made to the accompanying drawings.

FIG. 1a illustrates an example of a known headlamp comprising two housings, respectively front and rear.

FIG. 1b shows another embodiment of a known headlamp in which the second housing is fastened to the belt.

FIG. 2 illustrates a front perspective of a first embodiment of a compact headlamp in accordance with one embodiment of the invention, comprising an optical fiber arranged on the strip holding the lamp.

FIG. 3 illustrates a rear perspective view of the first embodiment showing an optical diffuser positioned at the rear of the holding strip and to which the optical fiber or fibers are connected.

FIG. 4 illustrates the detail of the body 21 of a compact lamp according to the first embodiment and comprising a light module enabling the connection of two optical fibers.

FIG. 5 illustrates the detail of the interface for connecting the two optical fibers to the light module 50 of the lamp.

FIG. 6 illustrates in greater detail the light module 50 comprising its light source and its connection and interface.

FIG. 7 illustrates the signaling device located at the rear or on a lateral face of the holding strip.

FIG. 8 is a rear view of a compact lamp according to the first embodiment.

FIG. 9 illustrates a second embodiment of a compact front lamp comprising a holding strip provided with two lateral signalings.

FIG. 10 illustrates a third embodiment comprising a holding strip having a woven optical fiber for the purpose of producing a desired display or pattern, for example a logo.

FIG. 11 illustrates a fourth embodiment of a compact headlamp comprising a holding strip composed of two parts, respectively semi-rigid and elastic.

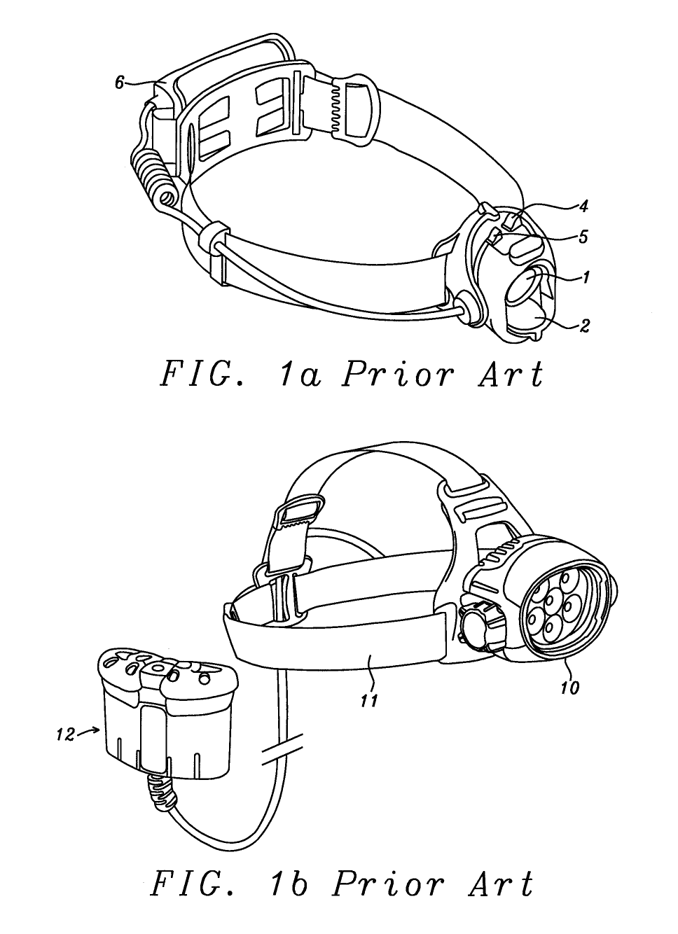

### DESCRIPTION

It will now be described how the structure of the headlamps, and in particular of the compact headlamps, can be modified very economically in order to introducing new signaling capabilities and functions of the greatest interest.

The following description will be specifically adapted to compact lamps which, clearly, represent the category of headlamps that will benefit most from this new signaling functionality. However, it is clear that the introduction of the new signaling function in a headlamp is certainly not a limitation and that a person skilled in the art may adapt the present description to the production of any headlamp, in particular a specific lamp.

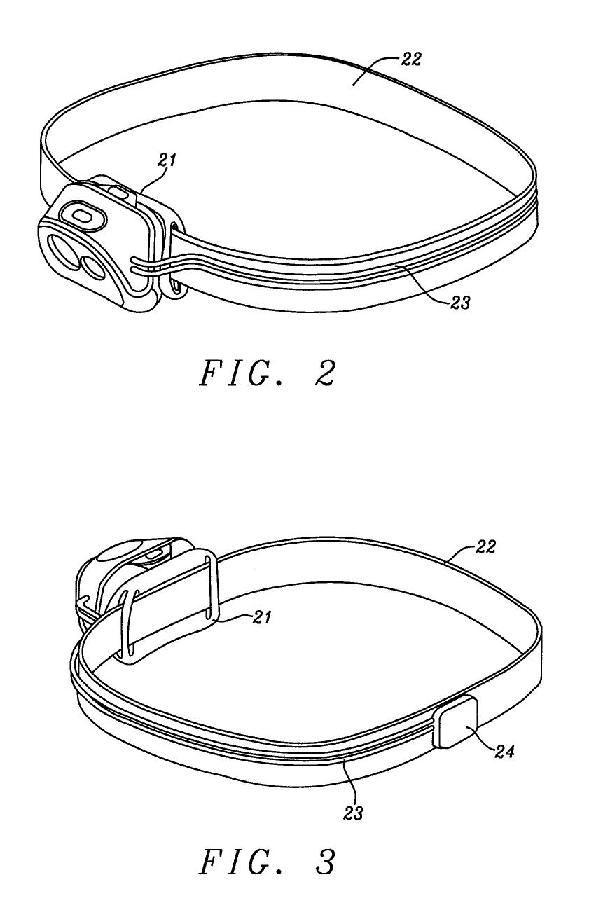

FIG. 2 illustrates a front perspective of a first embodiment of a compact headlamp in accordance with one embodiment of the present invention, comprising an optical fiber located on a lamp holding strip and allowing an optical coupling or connection between a first front housing and a luminous diffuser located at the rear. More particularly, the headlamp includes a compact housing or casing 21 which can be fixed at the front of a user's head by means of a holding strip 22 which may, for example, take the form of an elastic or semi-rigid strip or band. The holding strip 22 comprises one or more optical fibers 23 which are configured for rearwardly deflecting part of the light produced within the casing 21 and which is normally lost in conventional headlamps. To achieve this, as shown in the rear perspective view of FIG. 3, the headlamp further includes an optical signaling system, which may take the form of an optical diffuser 24 for example, and which is coupled to the front casing 21 thanks to the optical fiber or the bundle of optical fibers.

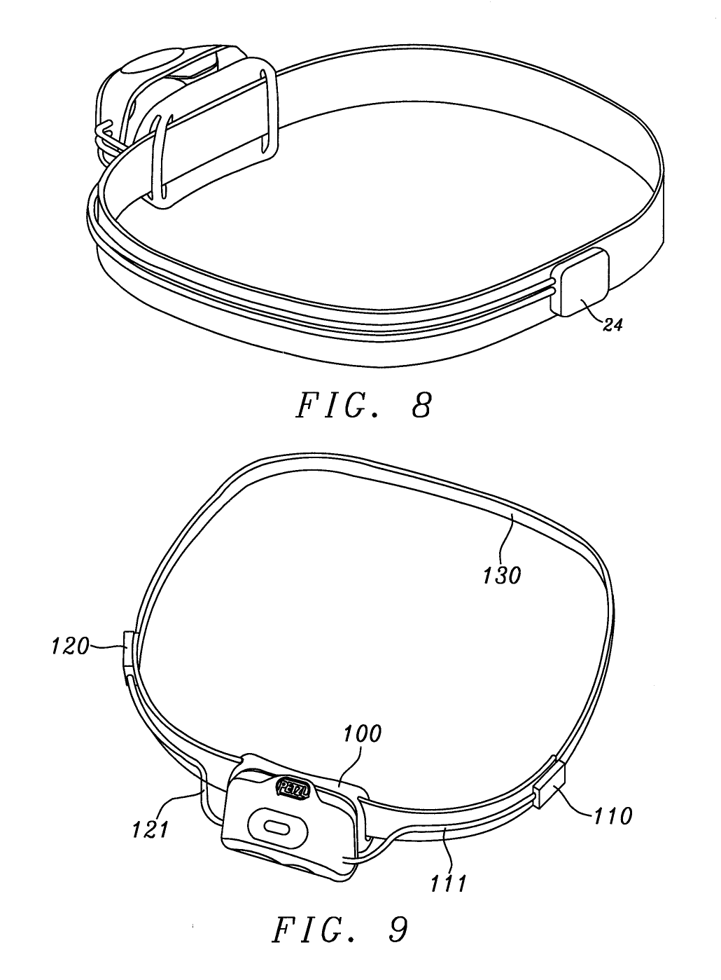

In the first embodiment which is described, the signaling system 24 will be located at the rear of the holding strip as shown in FIGS. 3 and 8, so that the headlamp user will be visible from the rear without requiring any additional light source.

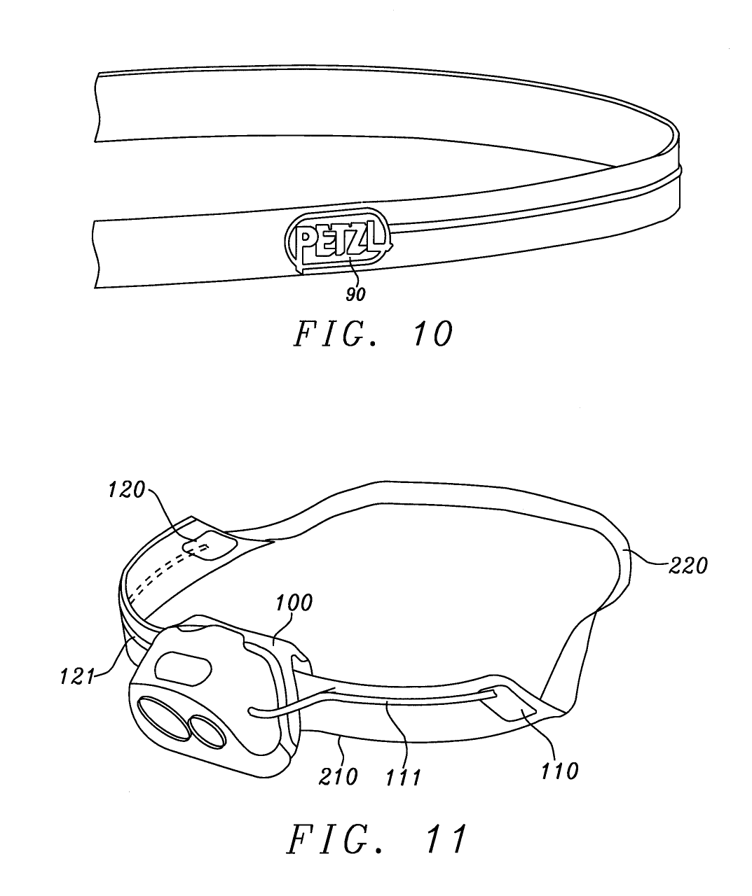

In a second embodiment, such as that illustrated in FIGS. 9 and 10, one or more signaling systems may be provided arranged laterally on the retaining strip 22.

Any other combination could be envisaged, and in particular any number of optical diffusers.

In one particular embodiment, the optical fiber or fibers will be arranged inside the strip itself so that the optical fiber or fibers will not be directly visible to the user. Alternatively, the latter can be fixed to the outside of the band, which will make it easier to produce in the case of a highly elastic strip or band.

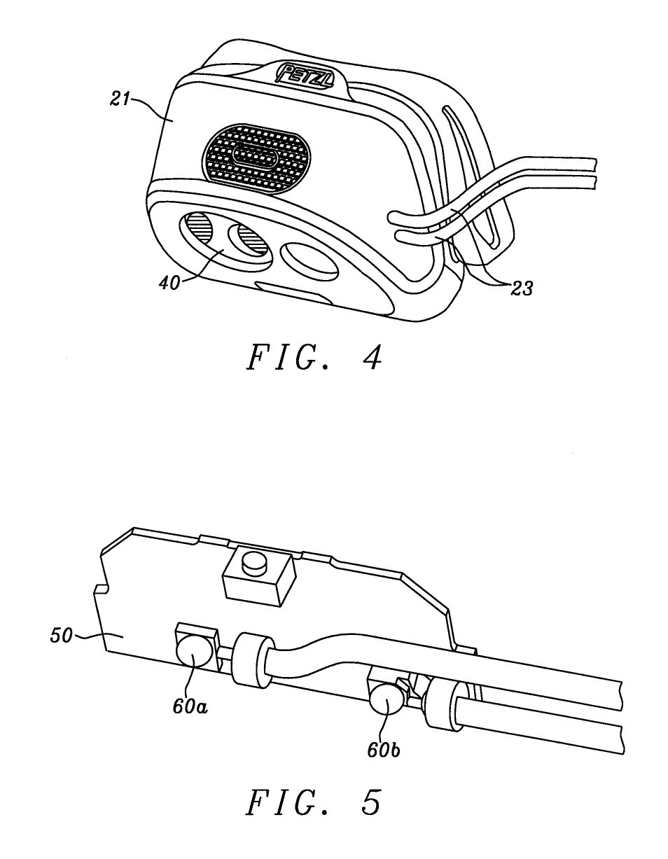

FIGS. 4, 5 and 6 illustrate the detail of the housing 21 of a compact lamp comprising a light module 50 provided with a light source 40, for example an LED, the light module 50 further comprising an interface for connecting two optical fibers.

FIG. 6 illustrates in greater detail light module 50 which comprises, in addition to the light source 40 (LED) and, in the vicinity of the latter, a first connection module 60a for the coupling of first end of a first optical fiber 23a. This will allow the first end of optical fiber 23a to be properly placed opposite the light source 40. In a particular embodiment, the light module 50 comprises a second connection module 60b close to the light source 40 or even, alternatively, a further light source for the second optical fiber 23b to once again enable a first end of the second optical fiber 23b to be placed opposite that second light source. Such an arrangement is described only for the purpose of illustration, in order to show the multiple possibilities and configurations without limitations. Clearly, all other timely combinations can be considered in relation to a given application.

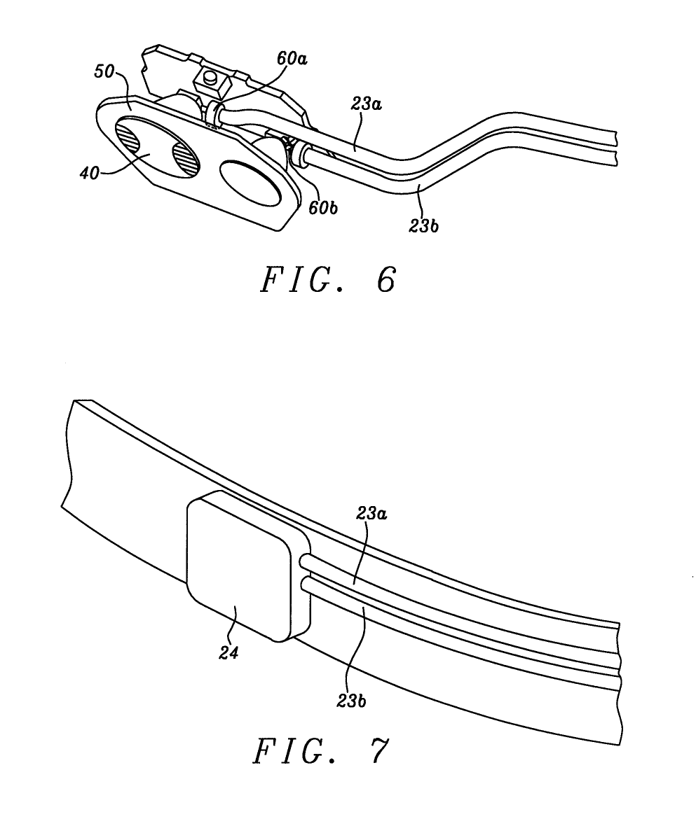

FIG. 7 illustrates the detail of the optical diffuser 24 of the first embodiment located at the rear of the band to which the second ends of the optical fibers 23a and 23b are connected.

FIG. 8 is a rear view of a compact lamp according to the first embodiment.

FIG. 9 illustrates a top view of a compact lamp 100 according to a second embodiment in which two optical diffusers 110 and 120 are disposed laterally on a holding strip 130, respectively to the left and to the right (with respect to the lamp holder). Two left and right optical fibers, respectively 111 and 121, serve for the light connection between the casing 100 and each of the diffusers 110 and 120.

FIG. 10 is an illustration of a third embodiment in which the optical fiber is intimately incorporated within the retaining strip and in particular by any weaving process, in order to make the strip lighting. To achieve this, the optical fiber or fibers may constitute the weft yarns or the warp yarns and are optionally combined with conventional fibers, for example cotton, linen, silk or any synthetic textile fiber. The fibers may be grouped into one or more beams and thus constitute a number of light patterns which may appear on the headlamp holding strip. It is thus possible to advantageously emphasize a logo 90 or a specific pattern represented on the holding strip.

The light coupling ends of the fibers constituting the beam(s) will be connected to the light module housed inside the headlamp and the other ends of these same fibers will be directly coupled to the diffuser 24, for example.

FIG. 11 illustrates a fourth embodiment of a headlamp comprising a casing to which is connected a complex holding strip comprising two parts. The holding strip comprises a first rigid or semi-rigid front part 210 on which the housing 100 of the compact lamp is fixed. The holding strip further comprises a second resilient part 220, making it possible to facilitate the fixing of the strip to the head of a user.

In the arrangement shown in FIG. 11, the optical fibers 111 and 121 are exclusively arranged on the first portion 210 of the light strip and are each connected to a lateral optical diffuser, respectively right 120 and left 110, also arranged on the front part of the headband 210, so that fixing the optical fiber or bundle of optical fibers 111/121, respectively right and left, will pose no major difficulty.

In the fourth embodiment illustrated in FIG. 11, therefore, there are two lateral signaling systems, both positioned on the rigid or semi-rigid front part of the holding strip, closed by the elastic part 220, which elastic part 220 will be devoid of any optical fiber.

This arrangement is particularly advantageous because it permits, in addition to the possibility of opting for a strip comprising a very elastic rear part ensuring the fixing of the front lamp on the head of the user, to provide two lateral signals, respectively at the right and at the left. This double lateral signaling can easily be substituted for a rear signaling as shown in FIGS. 3 and 8 and it has been observed in practice that the multiple head movements of a front lamp carrier make it readily visible one or the other of the two lateral signals.

The great advantage of the embodiments described above lies in the fact that, first of all, the headlamp offers an economic structure based on a single housing and then the new signaling function which is provided by the present invention can be powered with part of the light which is produced inside the lamp housing 21 and which is normally lost in conventional headlamp.

Consequently, no additional power consumption is required to carry out this new signaling function.

The invention thus makes possible a particularly effective functionality by means of an elegant and particularly economical embodiment.

What is claimed is:

1. A headlamp comprising a housing including a light module comprising a light source and a holding strip for allowing the housing to be fixed to the head of a user, wherein the light module comprises a module for connecting one or more optical fiber(s); and
the holding strip comprises one or more optical fiber(s) having first and second end, the first end being coupled to said connection module and said second end being coupled to at least one optical diffuser.

2. The headlamp according to claim 1 wherein the optical fiber or fibers is/are arranged within the holding strip.

3. The headlamp according to claim 1 wherein the optical fiber or fibers is/are arranged outside the holding strip.

4. The headlamp according to claim 1 wherein said optical diffuser is located at the rear of the holding strip.

5. The headlamp according to claim 1 wherein the holding strip comprises two lateral optical diffusers.

6. The headlamp according to claim 1 wherein the optical fiber or fibers is/are incorporated within the holding strip by means of a weaving process so as to form a pattern or a luminous logo.

7. The headlamp according to claim 6 wherein the optical fiber or fibers is/are incorporated within the holding strip by any weaving process, the optical fiber or fibers constituting the weft yarns or the warp yarns and are optionally combined with conventional fibers, wherein the optical fiber(s) are grouped in one or more beams so as to carry out lighting patterns.

8. The headlamp according to claim 1, wherein said holding strip comprises:
a first rigid or semi-rigid front part on which the optical fiber or fibers and said optical diffuser are positioned; and
a second elastic rear part making it possible to close the retaining strip and facilitating the fixing of the latter to the head of a user.

9. A headlamp according to claim 1, wherein the lamp is a compact lamp comprising the light module and a power source.

10. A method of providing a headlamp comprising a housing including a light module comprising a light source and a holding strip for allowing the housing to be fixed to the head of a user,
wherein the light module comprises a module for connecting one or more optical fiber(s); and
the holding strip comprises one or more optical fiber(s) having first and second end, the first end being coupled to said connection module and said second end being coupled to at least one optical diffuser.

11. The method according to claim 10 wherein the optical fiber or fibers is/are arranged within the holding strip.

12. The method according to claim 10 wherein the optical fiber or fibers is/are arranged outside the holding strip.

13. The method according to claim 10 wherein said optical diffuser is located at the rear of the holding strip.

14. The method according to claim 10 wherein the holding strip comprises two lateral optical diffusers.

15. The method according to claim 10 wherein the optical fiber or fibers is/are incorporated within the holding strip by means of a weaving process so as to form a pattern or a luminous logo.

16. The method according to claim 15 wherein the optical fiber or fibers is/are incorporated within the holding strip by any weaving process, the optical fiber or fibers constituting the weft yarns or the warp yarns and are optionally combined with conventional fibers, wherein the optical fiber(s) are grouped in one or more beams so as to carry out lighting patterns.

17. The method according to claim 10, wherein said holding strip comprises:
a first rigid or semi-rigid front part on which the optical fiber or fibers and said optical diffuser are positioned; and
a second elastic rear part making it possible to close the retaining strip and facilitating the fixing of the latter to the head of a user.

18. The method according to claim 10, wherein the lamp is a compact lamp comprising the light module and a power source.
